(19) United States
(12) Patent Application Publication
(10) Pub. No.: US 2009/0208746 A1
(43) Pub. Date: Aug. 20, 2009

(54) Method of Sol-Gel Processing

(76) Inventor: Crina Silvia Suciu, Bergen (NO)

Correspondence Address: ABELMAN, FRAYNE & SCHWAB, 666 THIRD AVENUE, 10TH FLOOR, NEW YORK, NY, 10017, US

(21) Appl. No.: 12/085,973

(22) PCT Filed: Dec. 1, 2006
(86) PCT No.: PCT/NO2006/000451

§ 371 Date: Jan. 21, 2009

(30) Foreign Application Priority Data
Dec. 2, 2005 (NO) 20055723

(51) Int. Cl. B32B 5/16; B01J 13/00

(52) U.S. Cl. 428/402; 516/99; 977/773

(57) ABSTRACT

Methods of sol-gel processing for preparing of stabilized or doped gels and nanoparticles are described. The invention also relates to stabilized or doped gels and nanoparticles prepared by the described methods.

### FIELD OF INVENTION

The present invention relates to a method of sol-gel processing for preparing stabilized or doped gels and nanoparticles, and also gels and nanoparticles produced by said methods.

### BACKGROUND OF THE INVENTION

The interest for nanostructured materials, which are synthesized from particles smaller than 100 nanometers, has been growing in the last decades. The interest has been stimulated by the large variety of applications in industries such as aerospace, steel, cosmetics, health, automotive, bioengineering, optoelectronics, computers, and electronics. Research to develop applications have resulted in technologies that make it possible to obtain multilayered films, porous pillars, thin films, nanocrystalline materials, nanopowders and clusters for e.g. paints, antiseptics, nanocomposites, drugs, biomedical implants and military components.

It is very well known that materials with nanoscale grain size show different properties from the same material in bulk form. These unique properties are related to the large number of surface or interface atoms. Nanostructured materials have good refractory properties, good chemical resistance, good mechanical resistance and hardness both at normal and high temperatures; they are especially amenable to sintering and reactions with different oxides. It has also been shown that the large number of surface atoms present in these materials influences the optical, electrical and magnetic properties.

It is now well recognized that the mechanical, electrical, chemical as well as catalytic properties of zirconia can be improved by using nanopowders instead of conventional micron-sized zirconia. When synthesizing of conventional Zr based materials the medium size of the particles is normally in the region of 10 microns, which is generally equivalent to 10¹⁵ atoms. Particles with diameters ranging between 0.1 and 1 micrometer are considered fine particles and are usually made up of 10⁹-10¹⁰ atoms. Particles on a nanoscale, with dimensions ranging from 1 to 100 nanometers (nm) in at least one direction are of particular interest. Particles consisting of 200-300 atoms are designated clusters and their surface atoms can represent up to 80-90% of the total number of the atoms in the particle.

A method for obtaining nanoparticles that does not need expensive equipment is the sol-gel route. The sol-gel method is based on molecular synthesis of nanoparticles wherein the particles are built up by molecule-by-molecule addition. During the process of nanopowder formation close control over the nucleation and growth of the particles is required because the particles easily adhere and form agglomerates.

Inventor's co-pending application describes novel processes for the preparation of gels and nanoparticles using mono and disaccharides as precursors in the sol-gel method.

The present invention relates to the preparation of stabilized gels and nanoparticles using pectin and mono or disaccharides as precursors in the sol-gel method.

Yttrium stabilized zirconia, also called YSZ, is currently the most important ceramic oxygen ion conducting material. It is used in the anode and the electrolyte of solid oxide fuel cells (SOFC) in oxygen gas sensors, and in oxygen pumps.

Doping zirconia, ZrO₂, with yttria, Y₂O₃ has two important effects. One is to stabilize the cubic crystal structure of the zirconia down to room temperature, avoiding the phase transitions that pure zirconia undergo during heating or cooling, with the attendant volume changes and possible mechanical stresses or failures. The other effect of doping with yttrium is that oxygen vacancies are generated in the material to maintain electrical neutrality as tetravalent zirconium ions are replaced by trivalent yttrium ions; two ions of y³⁺ correspond to an anionic vacancy V_{A} of O²⁻. These vacancies are responsible for the oxygen ion conductivity.

In solid oxide fuel cells internal resistance in the cell limits the current density through it. This resistance is due to slow reaction kinetics at the electrodes (“activation polarization”), ohmic resistance to the flow of ions through the electrolyte (“ohmic polarization”), and slow diffusion of the reactant/product gases to/from the catalyst surface in the electrodes (“concentration polarization”) [1,2]

A way of decreasing the ohmic polarization due to limited ionic conductivity of the electrolyte is to make the electrolyte thinner. If the electrolyte is between 5 and 30 micrometers the ohmic losses become small compared to the electrode losses [3]. A number of recent studies focus on the electrolyte and its manufacture [4-9]

Using YSZ nanoparticles as precursor material for the production of the SOFC electrolyte and anode may be advantageous in several respects.

Producing the electrolyte from nanoparticles allows it to be made thinner. Moreover, it can improve the quality of the electrolyte film, making the gas tightness better, and the microstress distribution more homogeneous. It is also claimed that a finer grain structure leads to higher ionic conductivity in grain boundaries [10], although some molecular dynamics studies indicate that some grain boundaries may act as resistances [11].

Another advantage of using nanoparticles as precursor powder for electrolytes is that the temperature necessary for sintering is reduced, reducing manufacturing costs.

A few articles [12,13] describe the production of YSZ nanoparticles for use in SOFC components.

### SUMMARY OF THE INVENTION

The present invention is directed to methods for sol-gel processing using inorganic metal salts and doping agents.

The present invention is also related to methods for producing nanosize particles from inorganic metal salts and doping agents.

The present invention is also directed to particles, sols and gels produced according to methods described herein.

The methods generally involve mixing together a solution containing an inorganic metal salt, a doping agent and water with pectin and a mono or disaccharide. A macromolecular dispersant molecule such as pectin may optionally be added. The resulting homogenous solution is dried at elevated temperature until it becomes completely gelatinized. Further thermal treatment of the dried gel will transform the material to nanoparticles.

Several parameters of the method can be manipulated, making the method highly tunable, and enabling production of stabilized/doped sols, gels and particles with various desired characteristics. Variables that can be controlled and which control the product characteristics include the choice of metal salts, the metal salt concentration, the choice of doping agent, the concentration of doping agent, ratio of mono or disaccharide solution to water, incubation temperature and time, and concentration of macromolecular dispersant.

### FIGURE LEGENDS

FIG. 1 is a schematic illustration of one embodiment of the invention, showing a process for the preparation of yttrium stabilized zirconium gels and particles as described in example 1.

FIG. 2 shows the result of thermal analyses of the yttrium stabilized prepared as described in example 1.

FIG. 3 is an electron microscopy yttrium stabilized zirconium gels and particles at 50 000 and 100 000 times magnification at 900° C.

FIG. 4 shoes X-ray diffraction of yttrium stabilized zirconium gels and particles at 1000° C.

### DETAILED DESCRIPTION OF THE INVENTION

The present invention relates to methods for production of stabilized gels and nanoparticles from inorganic metal salts. The methods offer sol-gel processing to produce a wide variety of materials of high quality.

The methods utilize homogenous nucleation and growth phenomena in inorganic solutions of mixed solvents, such as a mixed solvent of water and mono or disaccharides

The methods are applicable for production of sols, gels and nanoparticles from many metals such as aluminum, hafnium, silicon, zirconium, cerium, titanium, lanthanum, germanium, and tantalum, among others, by means of inorganic salts, e.g. nitrates, sulfates, sulfides, and chlorides of the same elements. Combinations of metals and salts can also be used. The concentration of the metal salt can range from about 0.005 M to about 0.5 M, more preferably from about 0.025 M to 0.02 M.

Preferred metals include zirconium, cerium and nickel, and the preferred salts used are ZrCl₄, ZrO(NO₃)₃xH₂O, ZrOCl₂x8H₂O, Ce(NO₃)₃.6H2O and NiCO₃, Ni(COOH)₂, Ni(NO₃)₂.6H₂O, NiSO₄.7H₂O.

In order to stabilize the gels and particles a doping or stabilizing agent is used. Preferred doping agents for zirconium oxide are Y₂O₃, CaO and MgO. Preferable yttrium is the doping agent, and a salt of yttrium, preferable Y(NO₃)_{3 6}H₂O. Preferred doping agents for cerium oxide are Gd₂O₃, Sm₂O₃, Pr₂O₃ and Nd₂O₃.

Organic solvents that can be used include mono and disaccharides, such as fructose and glucose, and sucrose.

A first aspect of the present invention is thus related to a method of sol-gel processing for the preparation of doped gels, characterized in that an inorganic metal salt, a doping agent, pectin, and mono or disaccharides are used, and that said method comprises the steps:
a) preparing a first aqueous solution comprising said inorganic metal salt and said doping agent, and preparing a second aqueous solution comprising said mono or disaccharides,
b) mixing the first and second solutions to a third solution at a temperature from about 80 to 100° C.,
c) incubating the combined solution from step b) at an elevated temperature of about 80 to 200° C. in order to gelatinize the third solution to a gel material.

A second aspect of the invention relates to a method of sol-gel processing for the preparation of doped nanoparticles, characterized in that an inorganic metal salt, a doping agent, pectin, and mono or disaccharides are used, and that said method comprises the steps:
a) preparing a first aqueous solution comprising said inorganic metal salt and said doping agent, and preparing a second aqueous solution comprising said mono or disaccharides,
b) mixing the first and second solutions to a third solution at a temperature from about 80 to 100° C.,
c) incubating the combined solution from step b) at an elevated temperature of about 80 to 200° C. in order to gelatinize the third solution to a gel material
d) thermal treatment of the gelatinized material from step c) at a temperature of from 500 to 1200° C., preferable from 700 to 1000° C.

Further aspects of the invention relates to gels and nanoparticles prepared by the methods indicated above.

Preferred embodiments of the invention relates to sol-gel processing wherein the metal salt contains a metal selected from the group consisting of aluminum, hafnium, silicon, zirconium, cerium, lanthanum, germanium, tantalum, nickel, combinations thereof, and combinations thereof with titanium.

Currently preferred methods use metal salt containing zirconium, cerium or nickel.

Preferred embodiments of the invention relates to sol-gel processing of stabilized gels and nano-particles where yttrium is used as a stabilizing or doping agent.

Preferable, said mono or disaccharides contains a compound selected from the group comprising sucrose, maltose, lactose, fructose and glucose, and most preferable the compound is sucrose.

The invention also relates to coated nanoparticles.

A preferred embodiment relates to YSZ nanoparticles produced by sol-gel processing by using sucrose and pectin as polymerization agents, characterized in that the particles after treatment at 500° C. have a crystallite size between 6-7 nm and particle size between 8-10nm.

A further preferred embodiment relates to YSZ nanoparticles produced by sol-gel processing by using sucrose and pectin as polymerization agents, characterized in that the particles after treatment at 1000° C. have a crystallite size of the cubic zirconia between 26-33 nm and particle size between 37 and 58nm

The invention is further illustrated by the following example, which is not to be construed in any way as imposing limitations upon the scope of the invention. On the contrary, it is to be clearly understood that resort may be had to various other embodiments, modifications, and equivalents thereof, which, after reading the description herein, may suggest themselves to those skilled in the art without departing from the spirit of the present invention.

### Experimental Section

### EXAMPLE 1

Preparation of yttrium stabilized zirconium based sols and nanoparticles by using sucrose and pectin as precursor.

Traditionally organic precursors used in the “chemical methods” referred to above are glycerol in the GN method, and ethylene glycol and citric acid in the Pechini method. The inventors of the present invention have surprisingly found that other precursor molecules can be used to obtain stabilized gels and nanoparticles.

With the methods according to the invention we are able to obtain ultra fine YSZ powders, replacing the organic compounds traditionally used with a mono or disaccharide.

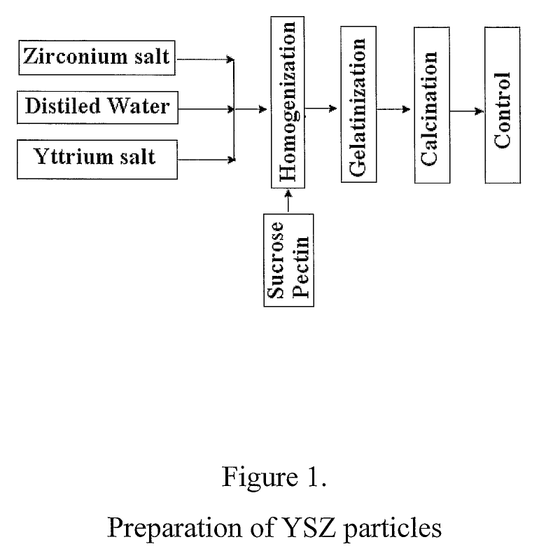

The salts ZrCl₄ (Sigma-Aldrich, technical purity) and Y(NO₃)₃ 6H₂O (Sigma-Aldrich, 99.9% purity) were used as zirconia and yttria precursors. Zirconium chlorate was dissolved in distilled water on a warming plate at 100° C. Next, the yttrium nitrate was added to the solution. After the homogenization, a sugar: pectin mixture with a mass ratio of 1:0.02 was added to the solution under continuous stirring. A general scheme showing the method is shown in FIG. 1.

The solution was slowly dried at the temperature of 100° C. until it became completely gelatinized. The dried brown gel was subjected to a thermal treatment at 900° C. in order to be transformed into stabilized zirconia nanoparticles.

The obtained powders were investigated in order to determine the mean size, the shape and the crystal structure of the particles. The analyses included TA—Thermal Analysis (Derivatograph Q 1500), BET analysis (Gemini 2380), TEM—Transmission Electron Microscopy (JEOL-JEM-100S Electron Microscope) and X-ray diffraction (Brucker D8-System) using Cu-K-alpha radiation.

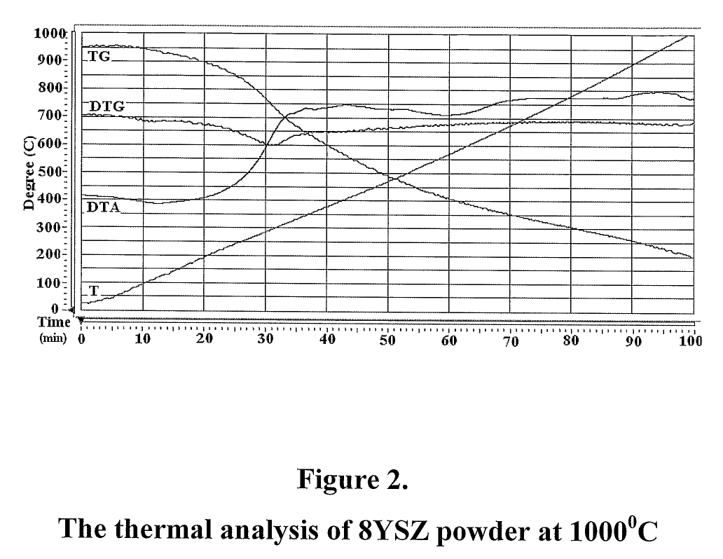

The thermal analyses were performed on dried YSZ gel using a Derivatograph Q 1500 (MOM Hungary) to determine the chemical and physical properties of the samples as a function of temperature or time based on the thermal effects that occur during heating or cooling (see FIG. 2). The maximum temperature was 1000° C. and the heating rate was 10° C./min. Analyzing the TG and TDG curves of the ZrO₂ samples an endothermic process involving 5% mass reduction occurs between 100 and 200° C. which can be due to elimination of the water residue. Between 200 and 350° C. an exothermic process involving 50% mass reduction occurs due to the oxidation of the organic components. This exothermic process continues with reduced speed up to 600° C. The total mass reduction is 75% and it occurs up to 1000° C. Another exothermic process can be noticed on the DTA curve between 600 and 980° C. This latter exotherm effect is due to the formation and crystallization of ZrO₂ continued with a process that can be attributed to the formation of a solid solution between the ZrO₂ and Y₂O₃ oxides. As a result the cubic crystal form is stabilized. Due to the multitude of observed thermal effects it is possible that some of the processes interfere in the given temperature ranges. A closer study, involving comparisons of data from TDG and XRD, is needed in order to have a better understanding of the exact processes that take place at different temperature values.

The specific surface area of the samples was also determined by nitrogen adsorption according to the BET adsorption isotherm. The apparatus used was a Gemini 2380 from Micromeritics. A single point analysis gave 18.26 m²/g, and a multipoint analysis 18.75 m²/g. both with very good reproducibility. Using a density for cubic ZrO₂ of 5900 kg/m³ and assuming the particles to be round, this would correspond to particle diameters of 55.69 nm and 54.24 nm, respectively.

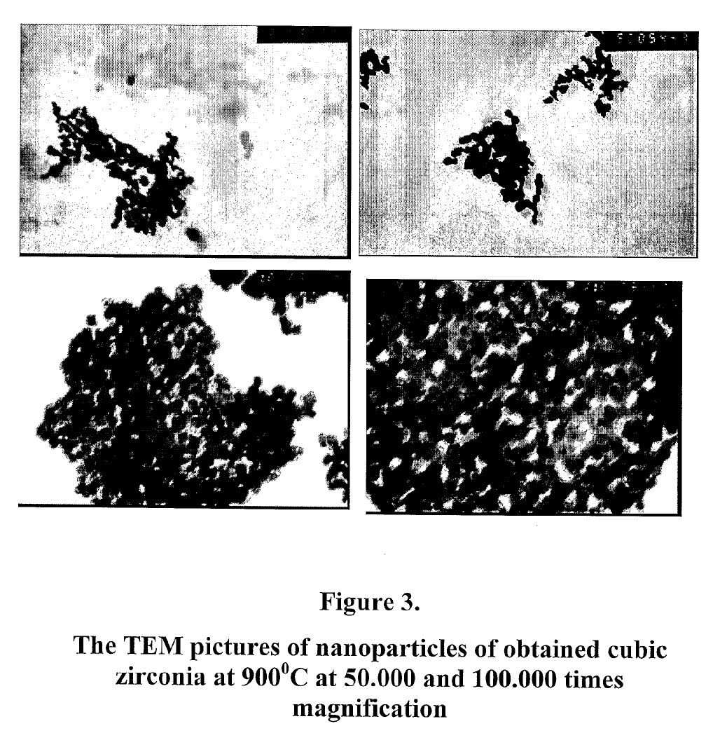

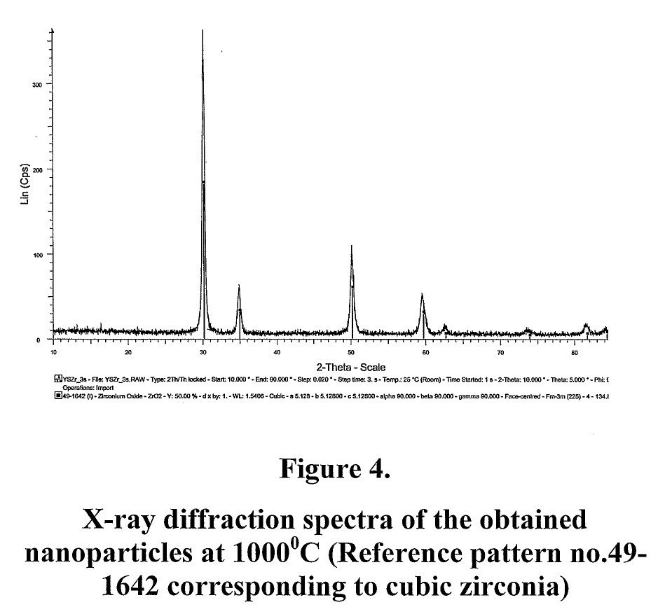

The morphology of the obtained powders was investigated using Transmission Electron Microscopy (TEM) performed by a JEOL—JEM—100S Electron Microscope. Distinct particles with fairly uniform dimensions ranging between 20-40 nanometres are observed at 50.000 and 100.000 times magnification for the powders sintered at 900° C. (see FIG. 3) The X-ray diffraction spectra obtained by Brucker D-8 Advance X-ray diffractometer showed that the obtained nanoparticles at 900° C. are stabilized in cubic crystal form (see FIG. 4) according to reference pattern no. 49-1642. The presence of other phases, such as single Y₂O₃ was not observed.

The crystallite size of the particles was determined using the Scherrer formula applied on the first three peaks of the obtained XRD spectrum. The λ value of the Culkalphal radiation used for determination is 0.15406 nm and the λ value is equal with 1. The Full Width at Half Maximum (FWHM) values determined from the XRD spectrum are shown in table 1. According with all these, the crystallite size for the three peaks are 26.04, 20.28 and 22.4 nm, respectively. So, the crystallite mean size for the whole spectrum is 22.91 nm which is in at least rough agreement with the BET and TEM determinations.

TABLE 1
The crystallite size of the samples at 900° C.

| | Peak 1 | Peak 2 | Peak 3 |
|---|---|---|---|
| Obs. max (degrees) | 30.115 | 34.842 | 50.156 |
| d (d (Obs. max) | 2.9651 | 2.5729 | 1.8173 |
| Full Width Half Max (degrees) | 0.351 | 0.456 | 0.435 |
| Crystallite Size (nm) | 26.04 | 20.28 | 22.40 |

### CONCLUSIONS

It is possible to produce nanoparticles of YSZ in relatively simple conditions and at low costs. The process lasts 30 hours at most and the total solution/complete solidification process takes less than 5 hours. Sucrose and pectin are cheap, non-toxic, available at industrial scale, easy to store and manipulate at low temperatures. The method is environmentally friendly since it is a water-based and uses two natural compounds as organic precursors. The common implementation existing in laboratories are sufficient, because the procedure does not require special or sophisticated equipment.

This reaction product may be used in synthesis processes because it requires lower temperatures and shorter periods of burning. One of the most interesting fields in which these nanoparticles can be used is Solid Oxide Fuel Cell components.

### REFERENCES

[1] Fuel Cell Handbook. US Dept. of Energy, Office of Fossil Energy, 5 edition, 2000

[2] Handbook of Fuel Cells, Fundamentals, Technology and Applications, volume 4: Fuel Cell Technology and Applications. John Wiley & Sons, 2003.

[3] F. Tietz, H.-P. Buchkremer, and D. Stover. Components manufacturing for solid oxide fuel cells. Solid State Ionics, 152-153:373-381, 2002.

[4] N. H. Menzler, R. Hansch, R. Fleck, G. Blass, H. P. Buchkremer, H. Schichl, and D. Srover. Densification of SOFC yttria-stabilized zirconia electrolytes through addition of sintering additives. Electrochemical Society Proceedings, 2003-07:238-245, 2003.

[5] T.-L. Wen, D. Wang, M. Chen, H. Tu, Z. Lu, Z. Zhang, N. Nie, and W. Huang. Material research for planar SOFC stack. Solid State Ionics, 148:513-519, 2002.

[6] I. R. Gibson, G. P. Dransfield, and J. T. S. Irvine. Concentration upon electrical properties and susceptibility to ageing of yttria-stabilised zirconias. Journal of European Ceramic Society, 18:661-667, 1998.

[7] A. Weber and E. Ivers-Tiffee. Materials and concepts for Solid Oxide Fuel Cells (SOFCs) in stationary and mobile applications. Journal of Power Sources, 127:273-283, 2004.

[8] E. Wanzenberg, F. Tietz, D. Kek, P. Panjan, and D. Stover. Influence of electrode contacts on conductivity measurements of thin YSZ electrolyte films and the impact on solid oxide fuel cells. Solid State Ionics, 164:121-129, 2003.

[9] F. Chen and M. Liu. Preparation of yttria-stabilised zirconia (YSZ) films on La0.85Sr0.15MnO3 (LSM) and LSM-YSZ.

[10] T. E. Konstantinova, I. A. Danilenlko, N. P. Pilipenko, and G. K. Volkova. Nanomaterials for SOFC electrolytes and anodes on the base of zirconia. Electrochemical Society Proceedings, 2003-07:153-159, 2003.

[11] C. A. J. Fisher and H. Matsubara. Oxide ion diffusion along grain boundaries in zirconia: A molecular dynamics study. Solid State Ionics, 113-115:311-318, 1998.

[12] D. Stover, H. P. Buchkremer, and S. Uhlenbruck. Processing and properties of the ceramic conductive multilayer device solid oxide fuel cell (SOFC). Ceramics International, 30.

[13] V. Esposito, C. D'Ottavi, S. Ferrari, S. Licoccia, and E. Traversa. New chemical routes for preparation of ultrafine NiO—YSZ powders for SOFC anode applications. Electrochemical Society Proceedings, 2003-07:643-652, 2003.

1.-57. (canceled)

58. A method of sol-gel processing for the preparation of doped gels, characterized in that an inorganic metal salt, a doping agent, pectin and mono or disaccharides are used, and that said method comprises the steps:
a) preparing a first aqueous solution comprising said inorganic metal salt and said doping agent, and preparing a second aqueous solution comprising said mono or disaccharides,
b) mixing the first and second solutions to a third solution at a temperature from about 80 to 100° C.,
c) incubating the combined solution from step b) at an elevated temperature of about 80 to 200° C. in order to gelatinize the third solution to a gel material.

59. The method according to claim 58, wherein the metal salt contains a metal selected from the group consisting of aluminum, hafnium, silicon, zirconium, cerium, lanthanum, germanium, tantalum, nickel, combinations thereof, and combinations thereof with titanium.

60. The method according to claim 59, wherein the zirconium salt is a salt selected from the group consisting of ZrCl₄, ZrO(NO₃)₃ and ZrOCl₂.

61. The method according to claim 58, wherein the concentration of inorganic salt in the third solution is in the range of 20 g/l to 60 g/l.

62. The method according to claim 58, wherein the doping agent is a salt selected from the group containing Y₂O₃, Sc₂O₃, CaO, MgO, Pr₂O₃, Nd₂O₃, Sm₂O and Gd₂O₃.

63. The method according to claim 58, wherein the first solution is prepared by first dissolving the inorganic metal salt in water, and thereafter adding the doping agent to this solution.

64. A method according to claim 58, wherein the solution of mono or disaccharides contains a compound selected from the group consisting of sucrose, maltose, lactose, fructose and glucose.

65. A gel produced according to the method of claim 58.

66. A gel produced according to the method of claim 59.

67. A gel produced according to the method of claim 60.

68. A gel produced according to the method of claim 61.

69. A gel produced according to the method of claim 62.

70. A gel produced according to the method of claim 63.

71. A gel produced according to the method of claim 64.

72. A method of sol-gel processing, characterized in that an inorganic metal salt, a doping agent, pectin and mono or disaccharides are used, and that said method comprises the steps:
a) preparing a first aqueous solution comprising said inorganic metal salt and said doping agent, and preparing a second aqueous solution comprising said mono or disaccharides;
b) mixing the first and second solutions to a third solution at a temperature from about 80 to 100° C.;
c) incubating the combined solution from step b) at an elevated temperature of about 80 to 200° C. in order to gelatinize the third solution to a gel material;
d) thermal treatment of the gelatinized material from step c) at a temperature of from 500 to 1200° C.

73. The method in accordance with claim 72, wherein the thermal treatment is at a temperature of from 700 to 1000° C.

74. A method in accordance with claim 72 for producing nanoparticles, wherein the nanoparticles are monodisperse.

75. A method of accordance with claim 74, wherein the nanoparticles are less than 100 nanometer in at least one dimension.

76. A gel produced according to the method of claim 72.

77. A gel produced according to the method of claim 73.

78. A gel produced according to the method of claim 74.

79. A gel produced according to the method of claim 75.

80. A material in the form of nanoparticles produced according to the method of claim 72.

81. A material in the form of nanoparticles produced according to the method of claim 73.

82. A material in the form of nanoparticles produced according to the method of claim 74.

83. A material in the form of nanoparticles produced according to the method of claim 75.

84. YSZ nanoparticles produced by sol-gel processing by using sucrose and pectin as polymerization agents, characterized in that the particles after treatment at 500° C. have a crystallite size between 6-7 nm and particle size between 8-10 nm.

85. YSZ nanoparticles produced by sol-gel processing by using sucrose and pectin as polymerization agents, characterized in that the particles after treatment at 1000° C. have a crystallite size of the cubic zirconia between 26-33 nm and particle size between 37 and 58 nm.
